(19) United States
(12) Patent Application Publication
(10) Pub. No.: US 2014/0067483 A1
(43) Pub. Date: Mar. 6, 2014

(54) APPARATUS AND METHOD FOR CONSTRUCTING RADAR CHART

(71) Applicant: ELECTRONICS AND TELECOMMUNICATIONS RESEARCH INSTITUTE, Daejeon (KR)

(72) Inventors: Sangjin JEONG, Daejeon (KR); Hyoung Jun KIM, Daejeon (KR)

(73) Assignee: Electronics and Telecommunications Research Institute, Daejeon (KR)

(21) Appl. No.: 13/848,472

(22) Filed: Mar. 21, 2013

(30) Foreign Application Priority Data
Aug. 30, 2012 (KR) 10-2012-0095676
Feb. 18, 2013 (KR) 10-2013-0017127

(51) Int. Cl. G06Q 10/06

(52) U.S. Cl. CPC G06Q 10/06393
USPC 705/7.39

(57) ABSTRACT

When an apparatus for constructing a radar chart receives evaluation scores and weighted values of a plurality of evaluation items from a user, the apparatus divides a single circle into sectors corresponding to the amount of the evaluation items on the basis of the weighted values of the respective evaluation items, marks evaluation scores of the respective evaluation items on the radiuses of the sectors corresponding to the respective evaluation items, and connects spots in which the evaluation scores are marked, to construct a radar chart, and calculates achievement of the radar chart.

### CROSS-REFERENCE TO RELATED APPLICATION

This application claims priority to and the benefit of Korean Patent Application Nos. 10-2012-0095676 and 10-2013-0017127 filed in the Korean Intellectual Property Office on Aug. 30, 2012 and Feb. 18, 2013, the entire contents of which are incorporated herein by reference.

### BACKGROUND OF THE INVENTION

(a) Field of the Invention

The present invention relates to an apparatus and method for constructing a radar chart.

(b) Description of the Related Art

A radar chart is used, for example, when there is a plurality of evaluation items with respect to a certain measurement target. A circle is divided into sections each having an equal space according to the number of respective evaluation items, spaces to be measured are divided at equal intervals concentrically starting from the center of the circle, dots are marked at corresponding positions according to quantized scores of respective evaluation items, and the dots are connected between evaluation items to generate lines to express balance among the evaluation items. A radar chart is advantageous in that a tendency of the respective items can be easily noticed because several measurement targets are superimposed. Such a radar chart technique may be commonly utilized. For example, in order to evaluate quality of various products, evaluation items such as stiffness, usability, price, design, client service, and the like are set up, scored, and constructed as a radar chart to recognize pros and cons and balance of the respective products.

In addition, a surface measure of overall performance (SMOP) using a radar chart technique has also been widely utilized as a benchmarking technique of measuring a degree of achievement with respect to a target including several evaluation items.

### SUMMARY OF THE INVENTION

The biggest shortcomings of the conventional radar chart technique and the SMOP technique lie in that evaluation items constituting a chart are assumed to have the same weight. For example, in case of determining a vehicle to be purchased by utilizing the radar chart technique, a vehicle price, performance, convenience, and the like may be considered as evaluation items. However, in the cause of utilizing the radar chart technique, the same weighted value cannot be given to the evaluation items by users. Thus, in order to more accurately make decisions, a method of applying different weighted values to respective evaluation items as necessary is required.

The present invention has been made in an effort to provide an apparatus and method for constructing a radar chart having advantages of allowing a user to accurately make decisions by providing different weighted values according to respective evaluation items of a chart.

An exemplary embodiment of the present invention provides an apparatus for constructing a radar chart showing a plurality of evaluation items with respect to a measurement target in a single circle. The apparatus for constructing a radar chart may include an input unit, a dividing unit, and a chart constructing unit. The input unit may receive evaluation scores and weighted values of the plurality of evaluation items from a user. The dividing unit may calculate angles of arcs of sectors corresponding to the respective evaluation items on the basis of the weighted values of the respective evaluation items, and divide the single circle into sectors corresponding to the amount of the evaluation items at the angles of the arcs of the sectors corresponding to the respective evaluation items. The radar chart constructing unit may mark evaluation scores of the respective evaluation items on radiuses of the sectors corresponding to the respective evaluation items, and connect spots in which the respective scores are marked, to construct a radar chart.

The apparatus for constructing a radar chart may further include an achievement calculating unit configured to calculate achievement of the radar chart by using the evaluation scores of the respective evaluation items and the angles of the arcs of the sectors corresponding to the respective evaluation items.

The apparatus for constructing a radar chart may further include an achievement calculating unit configured to calculate achievement with respect to the evaluation scores of the respective evaluation items over reference values of the respective evaluation items.

The chart constructing unit may mark the reference values of the respective evaluation items on the radiuses of the sectors corresponding to the respective evaluation items, and connect the spots in which the respective reference values are marked to construct a reference radar chart, and the achievement calculating unit may calculate achievement from similarity between areas of the radar chart and the reference radar chart.

At least some of the plurality of evaluation items may have different weighted values.

Another embodiment of the present invention provides a method for constructing a radar chart showing a plurality of evaluation items with respect to a measurement target in a single circle.

The method for constructing a radar chart may include: receiving evaluation scores and weighted values of the plurality of evaluation items from a user; dividing a single circle into sectors corresponding to the amount of evaluation items on the basis of the weighted values of the respective evaluation items; and marking the evaluation scores of the respective evaluation items on the radiuses of the sectors corresponding to the respective evaluation items, and connecting spots in which the respective evaluation scores are marked, to construct a radar chart.

The dividing of the single circle may include: calculating angles of arcs of the sectors corresponding to the respective evaluation items by using the weighted values of the respective evaluation items; and dividing the circle into sectors corresponding to the amount of the evaluation items at the angles of the arcs of the sectors corresponding to the respective evaluation items.

The method may further include calculating achievement of the radar chart by using the evaluation scores of the respective evaluation items and the angles of the arcs of the sectors corresponding to the respective evaluation items.

The calculating of achievement of the radar chart may include: receiving reference values of the respective evaluation items from the user; marking the reference values of the respective evaluation items on the radiuses of the sectors corresponding to the respective evaluation items, and connecting spots in which the reference values of the respective evaluation items are marked, to construct a reference radar chart; and calculating achievement from similarity between areas of the radar chart and the reference radar chart.

The similarity between the areas may be obtained by a degree of intersection between the radar chart and the reference radar chart.

### BRIEF DESCRIPTION OF THE DRAWINGS

FIG. 1 is a view illustrating an apparatus for constructing a radar chart according to an embodiment of the present invention.

FIG. 2 is a flowchart illustrating a method for constructing a radar chart according to an embodiment of the present invention.

FIG. 3 is a view illustrating an example of a radar chart according to an embodiment of the present invention.

FIG. 4 is a view illustrating an apparatus for constructing a radar chart according to another embodiment of the present invention.

FIG. 5 is a view illustrating an example of a radar chart constructed by the apparatus for constructing a radar chart illustrated in FIG. 4.

FIG. 6 is a view illustrating a method for calculating achievement of an i-th evaluation item over a reference radar chart in the radar chart according to an embodiment of the present invention.

FIG. 7 is a schematic view illustrating an apparatus for constructing a radar chart according to another embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Hereinafter, an apparatus and method for constructing a radar chart according to an embodiment of the present invention will be described in detail.

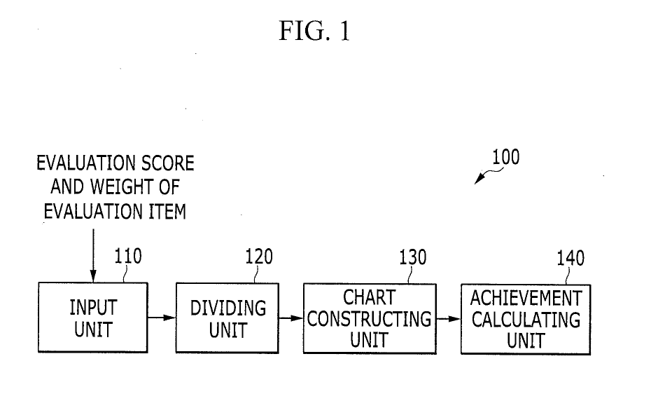

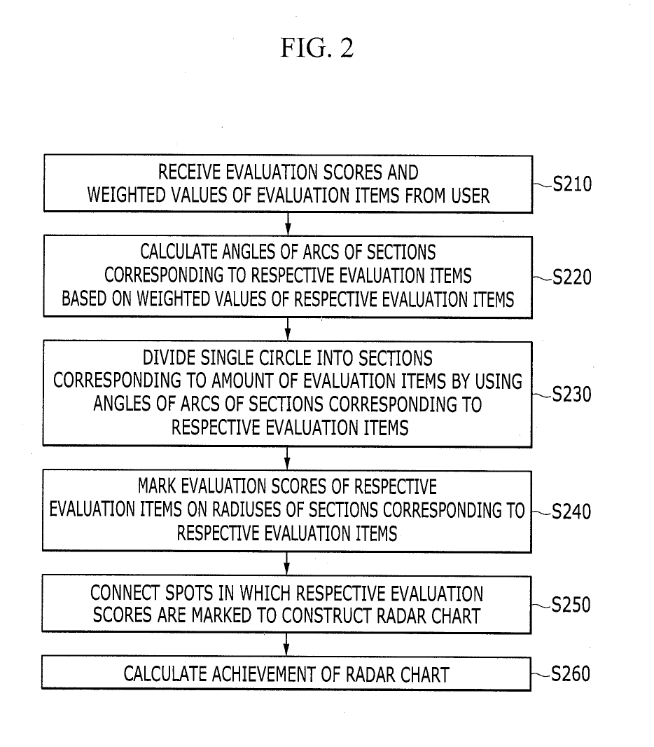

FIG. 1 is a view illustrating an apparatus for constructing a radar chart according to an embodiment of the present invention, and FIG. 2 is a flowchart illustrating a method for constructing a radar chart according to an embodiment of the present invention.

Referring to FIG. 1, the apparatus 100 for constructing a radar chart may include an input unit 110, a dividing unit 120, a chart constructing unit 130, and an achievement calculating unit 140.

Referring to FIG. 2, the input unit 110 receives evaluation scores and weighted values of respective evaluation items from a user (S210).

In the radar chart constructed by dividing a single circle into sectors corresponding to the amount of evaluation items, the dividing unit 120 calculates angles of arcs of the sectors corresponding to the respective evaluation items on the basis of weighted values of the respective evaluation items (S220).

In a case in which weighted values of n number of evaluation items are Wᵢ (1≦i≦n) and evaluation scores of the respective evaluation items are rᵢ (1≦i≦n, 1≦rᵢ≦n), an angle θᵢ of the arc of the sector representing a j-th evaluation item on the circular chart is calculated as shown in Equation 1 below. Here, a radius of the circle may be set to 1.

$${θ}_{i} = 360 \times \frac{{W}_{i}}{{\sum }_{j = 1}^{n} {w}_{j}} , 1 \leq i \leq n \qquad ( Equation 1 )$$

When the calculation of the angles of the arcs of the sectors corresponding to all evaluation items is finished, the dividing unit 120 divides the single circle into sectors corresponding to the amount of evaluation items by using the angles of the arcs of the sectors corresponding to the respective evaluation items (S230). Namely, the dividing unit 120 divides the single circle into sectors having angles of the arcs of the sectors corresponding to the respective evaluation items.

The cart constructing unit 130 marks evaluation scores of the respective evaluation items on the radiuses of the sectors corresponding to the respective evaluation items (S240), and connects the spots in which the respective evaluation scores are marked, to construct a radar chart (S250).

Thereafter, the achievement calculating unit 140 calculates achievement of the radar chart constructed by the chart constructing unit 130 (S260). The achievement calculating unit 140 may calculate achievement of the radar chart by using the evaluation scores of the respective evaluation items and the angles of the arcs of the sectors corresponding to the respective evaluation items.

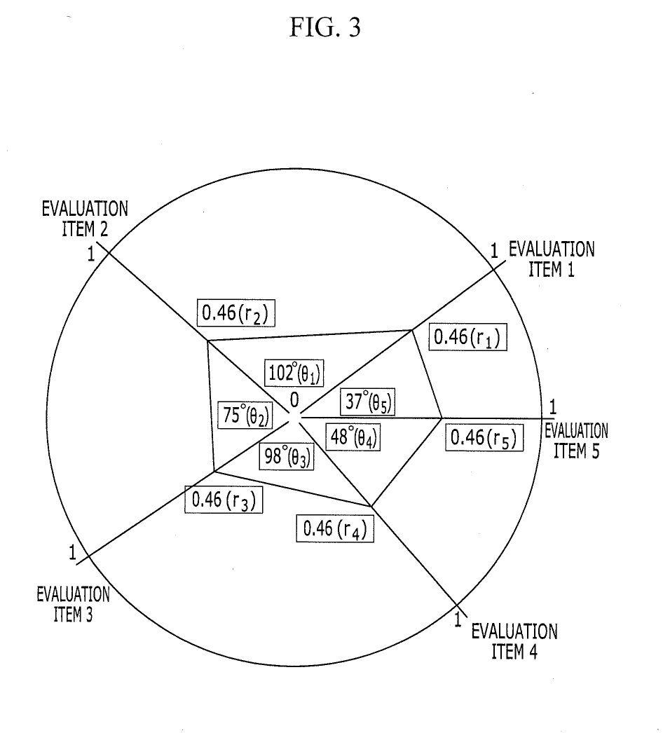

FIG. 3 is a view illustrating an example of a radar chart according to an embodiment of the present invention.

It is assumed that weight evaluation scores and weighted values are given to five evaluation items, respectively, as shown in Table 1 below.

TABLE 1

| Types of evaluation | | |
|---|---|---|
| items | Weighted value (wᵢ) (%) | Radius (rᵢ) |
| Evaluation item 1 | 28.47 | 0.59 |
| Evaluation item 2 | 20.84 | 0.46 |
| Evaluation item 3 | 27.10 | 0.39 |
| Evaluation item 4 | 13.42 | 0.47 |
| Evaluation item 5 | 10.17 | 0.59 |

In a case in which the evaluation items and the weighted values are given to the five evaluation items, respectively, as shown in Table 1, the dividing unit 120 calculates angles of the arcs of the sectors corresponding to the respective evaluation items by using Equation 1, and here, the calculated angles of the arcs of the sectors corresponding to the respective evaluation items may be obtained as shown in Table 2.

TABLE 2

| Type of | Weighted value (wᵢ) | Angle (θᵢ) | |
|---|---|---|---|
| evaluation item | (%) | (°) of allocated arc | Radius (rᵢ) |
| Evaluation item 1 | 28.47 | 102.492 | 0.59 |
| Evaluation item 2 | 20.84 | 75.024 | 0.46 |
| Evaluation item 3 | 27.10 | 97.56 | 0.39 |
| Evaluation item 4 | 13.42 | 48.312 | 0.47 |
| Evaluation item 5 | 10.17 | 36.612 | 0.59 |

The chart constructing unit 130 may mark the evaluation scores of the respective evaluation items on the radiuses of the sectors corresponding to the respective evaluation items, and connect the spots in which the respective evaluation scores are marked, to construct a radar chart illustrated in FIG. 3.

Achievement of the radar chart constructed as illustrated in FIG. 3 calculated by the achievement calculating unit 140 is calculated as

$$0.52 ( = \frac{\begin{matrix}\{ ( 0.59 * 0.46 ) * sin ( 102.492 ) + \\ ( 0.46 * 0.39 ) * sin ( 75.024 ) + ( 0.39 * 0.47 ) * sin ( 97.56 ) + \\ ( 0.47 * 0.59 ) * sin ( 48.312 ) + ( 0.59 * 0.59 ) * sin ( 36.612 ) \}\end{matrix}}{2} ) .$$

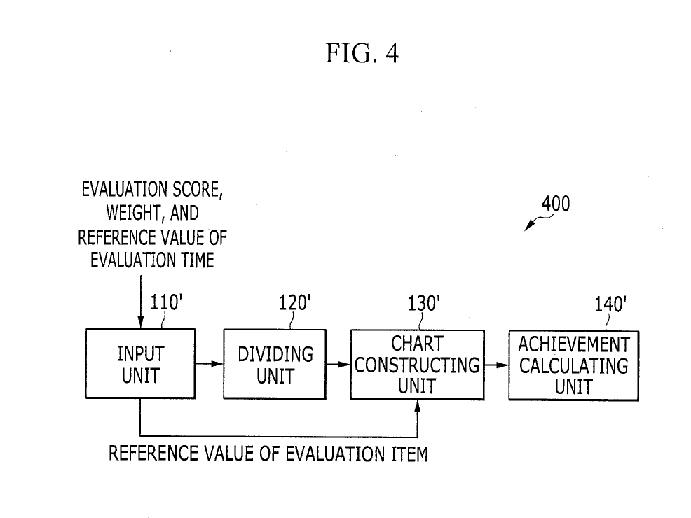

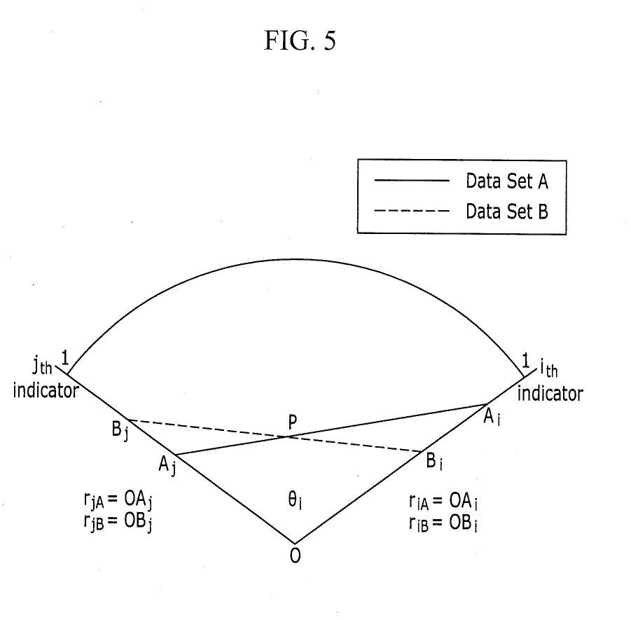

FIG. 4 is a view illustrating an apparatus for constructing a radar chart according to another embodiment of the present invention, and FIG. 5 is a view illustrating an example of a radar chart constructed by the apparatus for constructing a radar chart illustrated in FIG. 4.

Referring to FIG. 4, an input unit 110′ of an apparatus 400 for constructing a radar chart may further receive a reference value of each evaluation item from a user. Namely, in constructing a radar chart, the user may set a reference value for each evaluation item, and the input unit 110′ may receive the reference values of the respective evaluation items from the user and transfer the received reference values of the respective evaluation items to a chart constructing unit 130′.

A dividing unit 120′ may calculate angles of the arcs of the sectors corresponding to the respective evaluation items on the basis of the weighted values of the respective evaluation items through Equation 1, and divides a single circle into sectors corresponding to the amount of evaluation items by using the angles of the arcs of the sectors corresponding to the respective evaluation items.

As described above, the chart constructing unit 130′ marks evaluation scores of the respective evaluation items on the radiuses of the sectors corresponding to the respective evaluation items and connects the spots in which the respective evaluation scores are marked, to construct a radar chart. Also, the chart constructing unit 130′ marks reference values of the respective evaluation items on the radiuses of the sectors corresponding to the respective evaluation items and subsequently connects the spots in which the reference values of the respective evaluation items are marked, to construct a reference radar chart.

For example, in a case in which evaluations scores and weighted values as shown in Table 1 are given to the five evaluation items, respectively, and reference values are given to the five evaluation items, respectively, as shown in Table 3, the chart constructing 130′ may construct a radar chart (the solid line) and a reference radar chart (the dotted line) as shown in FIG. 5.

TABLE 3

| Type of evaluation items | Reference value |
|---|---|
| Evaluation item 1 | 0.6 |
| Evaluation item 2 | 0.3 |
| Evaluation item 3 | 0.46 |
| Evaluation item 4 | 0.57 |
| Evaluation item 5 | 0.76 |

Thereafter, an achievement calculating unit 140′ calculates achievement of the radar chart over the reference radar chart.

Data set ‘A’ indicates an evaluation score of each evaluation item and data set ‘B’ indicates a reference value of each evaluation item. Here, achievement of the data set A including n number of evaluation items over the data set ‘B’ may be calculated by Equation 2. Namely, achievement of the radar chart over the reference radar chart may be calculated by measuring a degree of intersection of the two radar charts as a numerical value.

$$S ( {R}_{A} \vert {R}_{B} ) = {\sum }_{i = 1}^{n} \frac{{θ}_{i}}{360} \cdot S ( {A}_{ij} \vert {B}_{ij} ) , \\ where \\ {\sum }_{i}^{n} {θ}_{i} = 360 \qquad ( Equation 2 )$$

Here, radar chart R is a set of polygons Aᵢⱼ or Bᵢⱼ which do not have a common element, 1≦i≦n, and j is i+1 mod n. The polygon Aᵢⱼ may be a polygon including vertices O, Aᵢ, and Aⱼ. Similarly, the polygon Bᵢⱼ may be a polygon including vertices O, Bᵢ, and Bⱼ.

$$S ( {A}_{ij} \vert {B}_{ij} ) = \{ \begin{matrix}1 , if {A}_{ij} includes {B}_{ij} \\ \frac{{A}_{ij}}{{B}_{ij}} , if {B}_{ij} includes {A}_{ij} \\ \frac{{r}_{{j}_{B}} \cdot {r}_{{i}_{B}} - Q}{{r}_{{j}_{B}} \cdot {r}_{{i}_{B}}} , if {r}_{{i}_{A}} > {r}_{{i}_{B}} and {r}_{{j}_{A}} < {r}_{{j}_{B}} \\ \frac{{r}_{{j}_{B}} \cdot {r}_{{i}_{B}} - {Q}^{′}}{{r}_{{j}_{B}} \cdot {r}_{{i}_{B}}} , if {r}_{{i}_{A}} < {r}_{{i}_{B}} and {r}_{{j}_{A}} > {r}_{{j}_{B}}\end{matrix} \qquad ( Equation 3 )$$

Here, Q and Q′ may be expressed by Equation 4.

$$Q = \frac{{r}_{{i}_{A}} \cdot {{r}_{{i}_{B}} ( {r}_{{j}_{B}} - {r}_{{j}_{A}} )}^{2}}{{r}_{{j}_{A}} ( {r}_{{i}_{A}} - {r}_{{i}_{B}} ) + {r}_{{i}_{A}} ( {r}_{{j}_{B}} - {r}_{{j}_{A}} )} \\ {Q}^{′} = \frac{{r}_{{j}_{A}} \cdot {{r}_{{j}_{B}} ( {r}_{{i}_{B}} - {r}_{{i}_{A}} )}^{2}}{{r}_{{i}_{A}} ( {r}_{{j}_{A}} - {r}_{{j}_{B}} ) + {r}_{{j}_{A}} ( {r}_{{i}_{B}} - {r}_{{i}_{A}} )} \qquad ( Equation 4 )$$

For example, when the radar chart (the solid line) and the reference radar chart (the dotted line) as illustrated in FIG. 5 are given, achievement of the radar chart over the reference radar chart according to Equation 2 may stand at 89.6%.

In making certain decisions through the achievement of the radar chart over the reference radar data, how much the measured values correspond to the reference of the decision making may be measured to be determined.

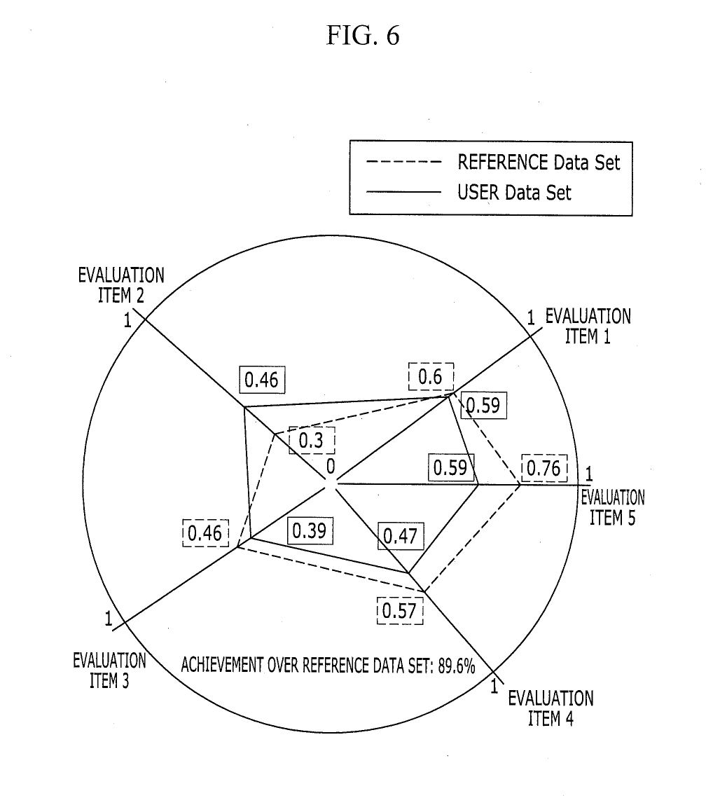

FIG. 6 is a view illustrating a method for calculating achievement of an i-th evaluation item over a reference radar chart in the radar chart according to an embodiment of the present invention, and Equation 2 is verified with reference to FIG. 6.

Referring to FIG. 6, polygon Aᵤ may be a polygon comprised of O, Aᵢ, and Aⱼ. For example, the polygon Aᵢⱼ may be a triangle ΔOAᵢAⱼ. Here, O̅A̅ᵢ=rᵢ_{_{A}}, O̅A̅ⱼ̅=rⱼ_{_{A}}, ∠O=θᵢ, and rᵢ is an evaluation score of i-th evaluation item.

Similarity between areas of the two polygons Aᵢⱼ and Bᵢⱼ may be expressed by a ratio between the intersection areas of the two polygons Aᵢⱼ and Bᵢⱼ over the area of the polygon Bᵢⱼ. In other words, similarity between the area of the two polygons Aᵢⱼ and Bᵢⱼ may be expressed by Equation 5 shown below.

$$S ( {A}_{ij} \vert {B}_{ij} ) = \frac{Area of intersection of polygon {A}_{ij} and {B}_{ij}}{Area of polygon {B}_{ij}} \qquad ( Equation 5 )$$

Similarly, similarity between areas of the two radar charts R₁ and R₂ may be expressed by a ratio between intersection areas of the two radar charts R₁ and R₂ over the area of the radar chart R₂, and the similarity between the areas of the two radar charts R₁ and R₂ may be expressed by Equation 6 shown below.

$$S ( {R}_{1} \vert {R}_{2} ) = \frac{Area of intersection of radar charts {R}_{1} and {R}_{2}}{Area of radar chart {R}_{2}} \qquad ( Equation 6 )$$

When two polygons Aᵢⱼ and Bᵢⱼ are given and in case of r_{iA}≧r_{iB} and r_{jA}≧r_{jB}, it may be considered that the polygon Aᵢⱼ includes the polygon Bᵢⱼ. When i and j are given, similarity between areas of the two polygons Aᵢⱼ and Bᵢⱼ, i.e., S(Aᵢⱼ|Bᵢⱼ), may be calculated as expressed by Equation 3.

In detail, in the case in which the polygon Aᵢⱼ includes the polygon Bᵢⱼ, an intersection area of the two polygons Aᵢⱼ and Bᵢⱼ is Bᵢⱼ. Thus, S(R₁|R₂) is 1.

In a case in which the polygon Bᵢⱼ includes the polygon Aᵢⱼ, an intersection area of the two polygons Aᵢⱼ and Bᵢⱼ is Aᵢⱼ. Thus, S(R₁|R₂) is Aᵢⱼ/Bᵢⱼ.

In case of ∠Bⱼ=α,

$$\frac{ {B}_{i} {B}_{j}}{sin {θ}_{i}} = \frac{{OB}_{i}}{sin α}$$

according to the sine rule, and thus Equation 7 may be obtained.

$$sin α = \frac{{r}_{{i}_{B}} \cdot sin {θ}_{i}}{{B}_{i} {B}_{j}} \qquad ( Equation 7 )$$

When Menelaus' Theorem is applied to Equation 7, Equation 8 may be obtained.

$$\frac{{OA}_{i}}{{A}_{i} {B}_{i}} \cdot \frac{{B}_{i} P}{{PB}_{j}} \cdot \frac{{B}_{j} {A}_{j}}{{A}_{j} O} = - 1 \qquad ( Equation 8 )$$

When variables having values in Equation 8 are substituted, Equation 9 and Equation 10 may be obtained.

$$\begin{matrix}\frac{{r}_{{i}_{A}}}{{r}_{{i}_{A}} - {r}_{{i}_{B}}} \cdot \frac{{PB}_{i}}{{PB}_{j}} \cdot \frac{{r}_{{j}_{B}} - {r}_{{j}_{A}}}{{r}_{{j}_{A}}} = - 1 & ( Equation 9 ) \\ {PB}_{i} = \frac{{r}_{{j}_{A}} ( {r}_{{i}_{A}} - {r}_{{i}_{B}} ) \cdot {PB}_{j}}{{r}_{{i}_{A}} ( {r}_{{j}_{B}} - {r}_{{j}_{A}} )} & ( Equation 10 )\end{matrix}$$

Here, since BᵢBⱼ=PBᵢ+PBⱼ, PBⱼ may be calculated as expressed by Equation 11.

$${PB}_{j} = {B}_{i} {B}_{j} \cdot \frac{{r}_{{i}_{A}} ( {r}_{{j}_{B}} - {r}_{{j}_{A}} )}{{r}_{{j}_{A}} ( {r}_{{i}_{A}} - {r}_{{i}_{B}} ) + {r}_{{i}_{A}} ( {r}_{{j}_{B}} - {r}_{{j}_{A}} )} \qquad ( Equation 11 )$$

In FIG. 6, the area of ΔAⱼBⱼP is expressed by Equation 12.

$$\begin{matrix}Δ {A}_{j} {B}_{j} P = \frac{1}{2} \cdot {OA}_{j} \cdot {PB}_{j} \cdot sin α \\ = \frac{{r}_{{i}_{A}} \cdot {{r}_{{i}_{B}} ( {r}_{{j}_{B}} - {r}_{{j}_{A}} )}^{2}}{2 \{ {r}_{{j}_{A}} ( {r}_{{i}_{A}} - {r}_{{i}_{B}} ) + {r}_{{i}_{A}} ( {r}_{{j}_{B}} - {r}_{{j}_{A}} ) \}}\end{matrix} \qquad ( Equation 12 )$$

When the area of ΔOBⱼBᵢ is U, U may be expressed by Equation 13.

$$U = \frac{1}{2} \cdot {r}_{{j}_{B}} \cdot {r}_{{i}_{B}} \cdot sin {θ}_{i} \qquad ( Equation 13 )$$

When the area of ΔOBᵢPAⱼ is T, T may be expressed by Equation 14.

$$\begin{matrix}\begin{matrix}T = U - Δ {A}_{j} {B}_{j} P \\ = \frac{1}{2} \cdot {r}_{{j}_{B}} \cdot {r}_{{i}_{B}} \cdot sin {θ}_{i} - \\ \frac{{r}_{{i}_{A}} \cdot {{r}_{{i}_{B}} ( {r}_{{j}_{B}} - {r}_{{j}_{A}} )}^{2}}{2 \{ {r}_{{j}_{A}} ( {r}_{{i}_{A}} - {r}_{{i}_{B}} ) + {r}_{{i}_{A}} ( {r}_{{j}_{B}} - {r}_{{j}_{A}} ) \}} \\ = \frac{1}{2} ( {r}_{{j}_{B}} \cdot {r}_{{i}_{B}} - Q ) sin {θ}_{i} ,\end{matrix} & ( Equation 14 ) \\ Q = \frac{{r}_{{i}_{A}} \cdot {{r}_{{i}_{B}} ( {r}_{{j}_{B}} - {r}_{{j}_{A}} )}^{2}}{{r}_{{j}_{A}} ( {r}_{{i}_{A}} - {r}_{{i}_{B}} ) + {r}_{{i}_{A}} ( {r}_{{j}_{B}} - {r}_{{j}_{A}} )} & \end{matrix}$$

According to Equation 5, S(Aᵢⱼ|Bᵢⱼ) is T/U and Equation 15 may be obtained.

$$\frac{T}{U} = \frac{\frac{1}{2} ( {r}_{{j}_{B}} \cdot {r}_{{i}_{B}} - Q ) \cdot sin {θ}_{i}}{\frac{1}{2} \cdot {r}_{{j}_{B}} \cdot {r}_{{i}_{B}} \cdot sin {θ}_{i}} \qquad ( Equation 15 )$$

Thus, S(Aᵢⱼ|Bᵢⱼ) may be expressed by Equation 16.

$$S ( {A}_{ij} \vert {B}_{ij} ) = \frac{{r}_{{j}_{B}} \cdot {r}_{{i}_{B}} - Q}{{r}_{{j}_{B}} \cdot {r}_{{i}_{B}}} , \\ where Q = \frac{{r}_{{i}_{A}} \cdot {{r}_{{i}_{B}} ( {r}_{{j}_{B}} - {r}_{{j}_{A}} )}^{2}}{{r}_{{j}_{A}} ( {r}_{{i}_{A}} - {r}_{{i}_{B}} ) + {r}_{{i}_{A}} ( {r}_{{j}_{B}} - {r}_{{j}_{A}} )} \qquad ( Equation 16 )$$

When ∠Bᵢ=α and the foregoing method is similarly applied, S(Aᵢⱼ|Bᵢⱼ) with respect to the case of r_{iA}<r_{iB} and r_{jA}>r_{jB} may be obtained as expressed by Equation 17.

$$S ( {A}_{ij} \vert {B}_{ij} ) = \frac{{r}_{{j}_{B}} \cdot {r}_{{i}_{B}} - {Q}^{′}}{{r}_{{j}_{B}} \cdot {r}_{{i}_{B}}} , \\ where {Q}^{′} = \frac{{r}_{{j}_{A}} \cdot {{r}_{{j}_{B}} ( {r}_{{i}_{B}} - {r}_{{i}_{A}} )}^{2}}{{r}_{{i}_{A}} ( {r}_{{j}_{A}} - {r}_{{j}_{B}} ) + {r}_{{j}_{A}} ( {r}_{{i}_{B}} - {r}_{{i}_{A}} )} \qquad ( Equation 17 )$$

When similarity between the areas of the radar charts R_{A} and R_{B} is S(R_{A}|R_{B}), S(R_{A}|R_{B}) is the sum of S(Aᵢⱼ|Bᵢⱼ).

According to the foregoing defining, S(A₁₂|B₁₂) and S(Aₙ₁|ₙ₁) may be expressed by Equation 18.

$$\begin{matrix}S ( {A}_{12} \vert {B}_{12} ) = \frac{\begin{matrix}Area of intersection of \\ polygon {A}_{12} and {B}_{12}\end{matrix}}{Area of polygon {B}_{12}} \\ = \frac{{A}_{12} ⋂ {B}_{12}}{{B}_{12}}\end{matrix} \\ \begin{matrix}S ( {A}_{n 1} \vert {B}_{n 1} ) = \frac{\begin{matrix}Area of intersection of \\ polygon {A}_{n 1} and {B}_{n 1}\end{matrix}}{Area of polygon {B}_{n 1}} \\ = \frac{{A}_{n 1} ⋂ {B}_{n 1}}{{B}_{n 1}}\end{matrix} \qquad ( Equation 18 )$$

Here, wᵢ is a weighted value of Aᵢⱼ and Bᵢⱼ, 1≦i≦n, j is i+1 mod n, and

$${w}_{i} = \frac{{θ}_{i}}{360} .$$

Thus, weighted values of A₁₂ and Aₙ₁ may be calculated by Equation 19.

$$weight of {A}_{12} = weight of {B}_{12} = {w}_{1} = \frac{{θ}_{1}}{360} = \frac{{B}_{12}}{{\sum }_{ij} {B}_{ij}} = \frac{{A}_{12}}{{\sum }_{i , j} {A}_{ij}} \\ weight of {A}_{n 1} = weight of {B}_{n 1} = {w}_{n} = \frac{{θ}_{n}}{360} = \frac{{B}_{n 1}}{{\sum }_{i , j} {B}_{ij}} = \frac{{A}_{n 1}}{{\sum }_{i , j} {A}_{ij}} \qquad ( Equation 19 )$$

Thus, S(R_{A}|R_{B}) may be expressed by Equation 20.

$$\begin{matrix}S ( {R}_{A} \vert {R}_{B} ) = \frac{\begin{matrix}Area of intersection of \\ radar charts {R}_{A} and {R}_{B}\end{matrix}}{Area of radar chart {R}_{B}} \\ = \frac{{A}_{12} ⋂ {B}_{12}}{{\sum }_{ij} {B}_{ij}} + … + \frac{{A}_{n 1} ⋂ {B}_{n 1}}{{\sum }_{ij} {B}_{ij }} \\ = \frac{S ( {A}_{12} \vert {B}_{12} ) \cdot {B}_{12}}{{\sum }_{ij} {B}_{ij}} + … + \frac{S ( {A}_{n 1} \vert {B}_{n 1} ) \cdot {B}_{n 1}}{{\sum }_{ij} {B}_{ij}} \\ = S ( {A}_{12} \vert {B}_{12} ) \cdot {w}_{1} + … + S ( {A}_{n 1} \vert {B}_{n 1} ) \cdot {w}_{n} \\ = {\sum }_{ij} S ( {A}_{ij} \vert {B}_{ij} ) \cdot {w}_{i}\end{matrix} \qquad ( Equation 20 )$$

Namely, referring to Equation 20, it can be seen that S(R_{A}|R_{B}) may be expressed by Equation 2.

That is, when a radar chart including n number of evaluation items, n number of sectors having different weighted values exist, and achievement of the radar chart including the n number of sectors may be obtained as the sum of achievements of the respective sectors.

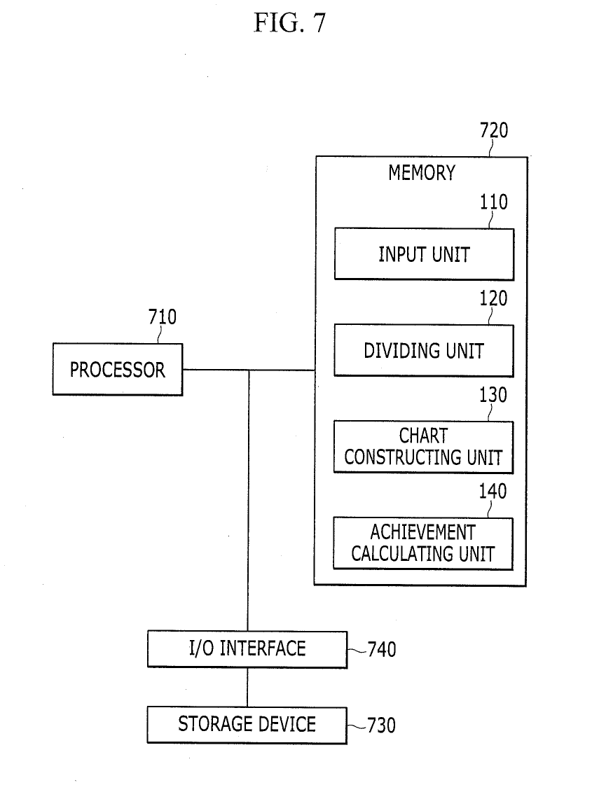

At least some of the functions of the apparatus and method for constructing a radar chart according to embodiments of the present invention as described above may be implemented by hardware or software combined with hardware. Hereinafter, an embodiment in which the apparatus and method for constructing a radar chart are combined to a computer system will be described in detail with reference to FIG. 7.

FIG. 7 is a schematic view illustrating an apparatus for constructing a radar chart according to another embodiment of the present invention, which shows a system that may be used to perform at least some of the functions of the input unit 110, the dividing unit 120, the chart constructing unit 130, and the achievement calculating unit 140 as described above.

Referring to FIG. 7, an apparatus 700 for constructing a radar chart includes a processor 710, a memory 720, a storage device 740, and an input/output (I/O) interface 730.

The processor 710 may be implemented as a central processing unit (CPU) or any other chip set, a microprocessor, or the like, and the memory 720 may be implemented as a medium like a random access memory (RAM), such as a dynamic random access memory (DRAM), a rambus DRAM (RDRAM), a synchronous DRAM (SDRAM), a static RAM (SRAM), or the like. The storage device 740 may be implemented as an optical disk such as a hard disk, a compact disk read only memory (CD-ROM), a CD writable (CD-RW), a digital video disk ROM (DVD-ROM), a DVD-RAM, a DVD-RW disk, a blu-ray disk, or the like, or a flash memory, or a permanent or volatile storage device such as various types of RAM. Also, the I/O interface 730 may allow the processor 710 and/or the memory 720 to access the storage device 740.

In this case, the processor 710 may load a program command for implementing at least some of the functions of the input unit 110 or 110′, the dividing unit 120 or 120′, the chart constructing unit 130 or 130′, and the achievement calculating unit 140 or 140′ to the memory 720 to provide control such that the foregoing operations are performed. The program command may be stored in the storage unit 730 or may be stored in a different system connected via a network.

The processor 710, the memory 720, the storage device 740, and the I/O interface 730 may be implemented in a single computer or in a plurality of computers in a distributed fashion.

According to embodiments of the present invention, a radar chart is constructed by giving different weighted values to respective evaluation items in a questionnaire including several independent evaluation items, and achievement of data given from a user for each evaluation item in the constructed radar chart, over reference data, is provided, thereby supporting accurate decision making.

Also, the embodiments of the present invention may not necessarily be implemented only through the foregoing devices and/or methods, but may also be implemented through a program for realizing functions corresponding to the configurations of the embodiments of the present invention, a recording medium including the program, or the like, and such an implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for constructing a radar chart showing a plurality of evaluation items with respect to a measurement target in a single circle, the apparatus comprising:
an input unit configured to receive evaluation scores and weighted values of the plurality of evaluation items from a user;
a dividing unit configured to calculate angles of arcs of sectors corresponding to the respective evaluation items on the basis of the weighted values of the respective evaluation items, and divide the single circle into sectors corresponding to the amount of the evaluation items on the basis of the angles of the arcs of the sectors corresponding to the respective evaluation items; and
a radar chart constructing unit configured to mark evaluation scores of the respective evaluation items on radiuses of the sectors corresponding to the respective evaluation items, and connect spots in which the respective scores are marked, to construct a radar chart.

2. The apparatus for constructing a radar chart of claim 1, further comprising
an achievement calculating unit configured to calculate achievement of the radar chart by using the evaluation scores of the respective evaluation items and the angles of the arcs of the sectors corresponding to the respective evaluation items.

3. The apparatus for constructing a radar chart of claim 1, further comprising
an achievement calculating unit configured to calculate achievement with respect to the evaluation scores of the respective evaluation items over reference values of the respective evaluation items.

4. The apparatus for constructing a radar chart of claim 3, wherein the chart constructing unit marks the reference values of the respective evaluation items on the radiuses of the sectors corresponding to the respective to evaluation items, and connects the spots in which the respective reference values are marked, to construct a reference radar chart, and
the achievement calculating unit calculates achievement from similarity between areas of the radar chart and the reference radar chart.

5. The apparatus for constructing a radar chart of claim 3, wherein the input unit receives the reference values of the respective evaluation items from the user.

6. The apparatus for constructing a radar chart of claim 1, wherein at least some of the plurality of evaluation items have different weighted values.

7. The apparatus for constructing a radar chart of claim 1, wherein the evaluation scores are determined to not exceed the radius of the circle.

8. A method for constructing a radar chart showing a plurality of evaluation items with respect to a measurement target in a single circle, the method comprising:
receiving evaluation scores and weighted values of the plurality of evaluation items from a user;
dividing a single circle into sectors corresponding to the amount of evaluation items on the basis of the weighted values of the respective evaluation items; and
marking the evaluation scores of the respective evaluation items on the radiuses of the sectors corresponding to the respective evaluation items, and connecting spots in which the respective evaluation scores are marked, to construct a radar chart.

9. The method of claim 8, wherein the dividing of the single circle comprises:
calculating angles of arcs of the sectors corresponding to the respective evaluation items by using the weighted values of the respective evaluation items; and
dividing the circle into sectors corresponding to the amount of the evaluation items at the angles of the arcs of the sectors corresponding to the respective evaluation items.

10. The method of claim 8, further comprising
calculating achievement of the radar chart by using the evaluation scores of the respective evaluation items and the angles of the arcs of the sectors corresponding to the respective evaluation items.

11. The method of claim 10, wherein the calculating of achievement of the radar chart comprises:
receiving reference values of the respective evaluation items from the user;
marking the reference values of the respective evaluation items on the radiuses of the sectors corresponding to the respective evaluation items, and connecting spots in which the reference values of the respective evaluation items are marked, to construct a reference radar chart; and
calculating achievement from similarity between areas of the radar chart and the reference radar chart.

12. The method of claim 11, wherein the similarity between the areas is obtained by a degree of intersection between the radar chart and the reference radar chart.

13. The method of claim 8, wherein at least some of the plurality of evaluation items have different weighted values.
